(19) United States
(12) Patent Application Publication
(10) Pub. No.: US 2018/0224279 A1
(43) Pub. Date: Aug. 9, 2018

(54) Thermal Gyroscope

(71) Applicant: Simon Fraser University, Burnaby (CA)

(72) Inventors: Jamal Bahari, Burnaby (CA); Carlo Menon, Coquitlam (CA)

(73) Assignee: Simon Fraser University, Burnaby (CA)

(21) Appl. No.: 15/891,240

(22) Filed: Feb. 7, 2018

Related U.S. Application Data
(60) Provisional application No. 62/456,608, filed on Feb. 8, 2017.

(51) Int. Cl. G01C 19/32; G01C 19/14

(52) U.S. Cl. CPC G01C 19/32; G01C 19/14

(57) ABSTRACT

An apparatus for sensing an angular rate of rotation in the presence of linear movement includes: (a) an enclosure for containing a fluid; (b) a heater disposed within the enclosure in fluid communication with the fluid; and (c) a plurality of temperature detectors disposed within the enclosure in fluid communication with the heater and the fluid, the plurality of temperature detectors being arranged symmetrically about the heater such that a superposition of a plurality of differential-temperature indications produced by the plurality of temperature detectors is maximally sensitive to the rotation while being minimally sensitive to the linear movement.

In some embodiments, the heater and the plurality of temperature detectors form a gyroscopic unit, and the apparatus includes a plurality of the gyroscopic units having an angular relationship. The angular relationship may have an angular-relationship value defined by a full-circle angle divided by a number of the gyroscopic units.

### BACKGROUND OF THE INVENTION

### 1. Field of Invention

The present invention is directed to apparatus and methods for sensing and measuring angular rate of rotation, also known as gyration, without being affected by linear acceleration.

### 2. Description of Related Art

Tracking and stabilizing motion have found numerous applications in the past decade. Complex motions can be resolved into series of linear and rotational motions whose rate of change are measured by the inertial sensors, i.e. accelerometers and gyroscopes. Accelerometers and gyroscopes are used in consumer electronics such as smart phones, game consoles, and digital cameras. Traditional mechanical accelerometers and gyroscopes served the aviation, defense, and automobile industries for decades; nonetheless, they were too bulky, power-hungry, and expensive to be adopted into the design of the consumer-grade electronics. A viable solution for the consumer electronics market has proven to be sensor miniaturization based on the Micro Electro Mechanical Systems (MEMS) technology.

Sensor miniaturization and batch fabrication by silicon micromachining considerably reduces power consumption and production costs. Among the MEMS contenders, the state of the art vibrating mass inertial sensors have dominated the market. In the past two decades, however, the thermal inertial sensors have also found solid ground. The MEMS thermal accelerometer has been around since 1997, and it has been commercialized. In contrast, the thermal gyroscope is still in the research and development stages and has not yet reached commercialization.

The major setback in the development of the thermal gyroscope is attributed to lack of resolution between the linear acceleration and gyration signals. It should be noted that the current research-only versions of the thermal gyroscopes have inherited the structures of the thermal accelerometers, making them more prone to detect the acceleration signal. A remedy for suppression of the acceleration signal is data acquisition and post processing; nevertheless, this approach is computationally intensive and does not provide real-time output. Consequently, the development of sensors and methods of measuring gyration while eliminating linear acceleration is necessary.

An object of the invention is to address the above shortcomings.

### SUMMARY

The above shortcomings may be addressed by providing, in accordance with one aspect of the invention, an apparatus for sensing an angular rate of rotation in the presence of linear movement. The apparatus includes: (a) an enclosure for containing a fluid; (b) a heater disposed within the enclosure in fluid communication with the fluid; and (c) a plurality of temperature detectors disposed within the enclosure in fluid communication with the heater and the fluid, the plurality of temperature detectors being arranged symmetrically about the heater such that a superposition of a plurality of differential-temperature indications produced by the plurality of temperature detectors is maximally sensitive to the rotation while being minimally sensitive to the linear movement.

The plurality of temperature detectors may form a plurality of differential-temperature node-pairs operable to simultaneously produce the plurality of differential-temperature indications. The plurality of temperature detectors may form a differential-temperature node-pair operable to sequentially produce each of the differential-temperature indications of the plurality of differential-temperature indications. The heater and the plurality of temperature detectors may form a gyroscopic unit. The apparatus may include a plurality of the gyroscopic units having an angular relationship. The heater of each of the gyroscopic units may include a plurality of collinear heating elements. All the temperature detectors of the plurality of gyroscopic units together may form a differential-temperature node-pair operable to sequentially produce each of the differential-temperature indications of the plurality of differential-temperature indications. The plurality of collinear heating elements may include first and second heating elements associated with first and second differential-temperature indications of the plurality of differential-temperature indications, respectively. The plurality of gyroscopic units may include first and second gyroscopic units having a 180-degree angular relationship. The angular relationship may have an angular-relationship value defined by a full-circle angle divided by a number of the gyroscopic units. The enclosure may include a plurality of enclosing partitions. The heater may be dimensioned for directionally uniform heating of the fluid.

In accordance with another aspect of the invention, there is provided a method of sensing an angular rate of rotation in the presence of linear movement. The method involves: (a) heating a fluid contained within an enclosure by a heater disposed within the enclosure and in fluid communication with the fluid; (b) producing a plurality of differential-temperature indications by a plurality of temperature indicators in fluid communication with the heater and the fluid; and (c) determining a superposition of the plurality of differential-temperature indications when the plurality of temperature detectors are arranged symmetrically about the heater such that the superposition is maximally sensitive to the rotation while being minimally sensitive to the linear movement.

Step (b) may involve simultaneously producing the plurality of differential-temperature indications by a plurality of differential-temperature node-pairs formed by the plurality of temperature indicators. Step (b) may involve sequentially producing each of the differential-temperature indications by a differential-temperature node-pair formed by the plurality of temperature indicators. Step (b) may involve producing the plurality of differential-temperature indications when the heater and the plurality of temperature detectors form a gyroscopic unit and the apparatus comprises a plurality of the gyroscopic units having an angular relationship. Step (a) may involve heating within each of the gyroscopic units by a plurality of collinear heating elements. Step (b) may involve sequentially producing each of the differential-temperature indications by a differential-temperature node-pair formed by all the temperature detectors of the plurality of gyroscopic units. Heating within each of the gyroscopic units by a plurality of collinear heating elements may involve heating by first and second heating elements associated with first and second differential-temperature indications of the plurality of differential-temperature indications, respectively. Sequentially producing each of the differential-temperature indications by a differential-temperature node-pair formed by all the temperature detectors of the plurality of gyroscopic units may involve producing the each differential-temperature indication when the plurality of gyroscopic units comprises first and second gyroscopic units having a 180-degree angular relationship. Step (b) may involve producing the plurality of differential-temperature indications when the angular relationship has an angular-relationship value defined by a full-circle angle divided by a number of the gyroscopic units of the plurality of gyroscopic units. Step (a) may involve heating the fluid contained within a plurality of enclosing partitions of the enclosure. Step (a) may involve heating directionally uniformly.

In accordance with another aspect of the invention, there is provided an apparatus for sensing an angular rate of rotation in the presence of linear movement. The apparatus includes: (a) heating means for heating a fluid contained within an enclosure, the heating means being disposed within the enclosure in fluid communication with the fluid; (b) temperature-detection means for producing a plurality of differential-temperature indications, the temperature detection means being in fluid communication with the heating means and the fluid; and (c) processing means for determining a superposition of the plurality of differential-temperature indications when the temperature-detection means is arranged symmetrically about the heating means such that the superposition is maximally sensitive to the rotation while being minimally sensitive to the linear movement.

In accordance with another aspect of the invention, there is provided a sensor/method for detecting and measuring the angular rate of rotation that is insensitive to linear acceleration, the sensor/method comprising of: at least, a confined volume containing a fluid or fluid mixture in gaseous or liquid state, at least one heating source causing the fluid expansion, and at least two temperature detectors symmetrically placed about the heating source(s). The dissipation power by the heating source(s) may be steady. The dissipation power by the heating source(s) may be varied by any type of waveform(s), in phase or out of phase.

The foregoing summary is illustrative only and is not intended to be in any way limiting. Other aspects and features of the present invention will become apparent to those of ordinary skill in the art upon review of the following description of embodiments of the invention in conjunction with the accompanying figures and claims.

### BRIEF DESCRIPTION OF THE DRAWINGS

In drawings which illustrate by way of example only embodiments of the invention:

FIG. 1 is a schematic representation of an apparatus for sensing an angular rate of rotation in the presence of linear movement according to a first embodiment of the invention having two differential-temperature node-pairs;

FIG. 2 is a schematic representation of the rotation sensing apparatus shown in FIG. 1, showing heat currents in the absence of rotation;

FIG. 3 is a schematic representation of the rotation sensing apparatus shown in FIG. 1, showing heat currents in the presence of rotation;

FIG. 4a is a schematic representation of the rotation sensing apparatus shown in FIG. 1, showing convention currents in the presence of linear acceleration in a first direction;

FIG. 4b is a schematic representation of the rotation sensing apparatus shown in FIG. 1, showing convention currents in the presence of linear acceleration in a second direction;

FIG. 5 is a schematic representation of an apparatus for sensing an angular rate of rotation in the presence of linear movement according to a second embodiment of the invention having a pair of gyroscopic units;

FIG. 6a is a schematic representation of the rotation sensing apparatus shown in FIG. 5, showing heat currents associated with a first phase of operation in the absence of rotation;

FIG. 6b is a schematic representation of the rotation sensing apparatus shown in FIG. 5, showing heat currents associated with a second phase of operation in the absence of rotation;

FIG. 7a is a schematic representation of the rotation sensing apparatus shown in FIG. 5, showing heat currents associated with a first phase of operation in the presence of rotation;

FIG. 7b is a schematic representation of the rotation sensing apparatus shown in FIG. 5, showing heat currents associated with a second phase of operation in the presence of rotation;

FIG. 8 is a schematic representation of the rotation sensing apparatus shown in FIG. 5, showing heat currents associated with a first phase of operation in the presence of rotation and showing convection currents in the presence of linear acceleration;

FIG. 9 is a schematic representation of the rotation sensing apparatus shown in FIG. 5, showing heat currents associated with a second phase of operation in the presence of rotation and showing convection currents in the presence of linear acceleration;

FIG. 10 is a schematic representation of an apparatus for sensing an angular rate of rotation in the presence of linear movement according to a third embodiment of the invention having four gyroscopic units;

FIG. 11 is a schematic representation of an apparatus for sensing an angular rate of rotation in the presence of linear movement according to a fourth embodiment of the invention having eight gyroscopic units; and

FIG. 12 is a schematic representation of an apparatus for sensing an angular rate of rotation in the presence of linear movement according to a fifth embodiment of the invention having straight and segmented temperature detectors.

### DETAILED DESCRIPTION

An apparatus for sensing an angular rate of rotation in the presence of linear movement includes: (a) heating means for heating a fluid contained within an enclosure, the heating means being disposed within the enclosure in fluid communication with the fluid; (b) temperature-detection means for producing a plurality of differential-temperature indications, the temperature detection means being in fluid communication with the heating means and the fluid; and (c) processing means for determining a superposition of the plurality of differential-temperature indications when the temperature-detection means is arranged symmetrically about the heating means such that the superposition is maximally sensitive to the rotation while being minimally sensitive to the linear movement.

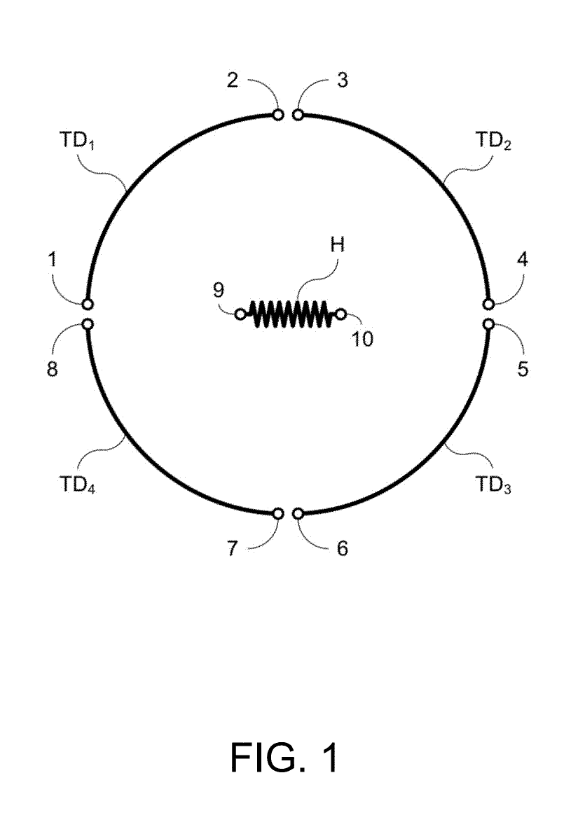

Referring to FIG. 1, the apparatus according to a first embodiment of the invention is shown. In a confined volume or cavity containing a fluid, a heating source H is immersed in the fluid and symmetrically surrounded by four temperature detectors TD1-TD4, shown in FIG. 1. Nodes 1, 4, 5, and 8 are connected to a reference voltage. Exemplary differential-temperature indications are given by the voltage differences between nodes 2|3 and nodes 6|7, which can be summed such that nodes 2 and 6 have same polarity opposite to the polarity of nodes 3 and 7. Exemplary differential-temperature node-pairs are given by the nodes 2|3 and by the nodes 6|7. The voltage differences between nodes 2|3 and nodes 6|7 occur simultaneously, and can be simultaneously measured to produce the exemplary differential-temperature indications as measured differential voltages. The measured differential voltages can be summed by signal processing or other electronic circuitry known to those of ordinary skill in the art.

The fluid may be a homogeneous or heterogeneous mixture, for example. The fluid may be a liquid, a gas, include both a liquid and a gas at the same time, be a liquid and be a gas at different times, or constitute any combination thereof for example. In any event, the fluid can be represented as fluid particles that can flow in response to a temperature gradient within the fluid.

The temperature detectors TD1-TD4 can be of any suitable type of temperature sensor, including thermocouple, resistance temperature detector, thermistor, other type of temperature sensor, or any combination thereof for example. For ease of illustration, the exemplary temperature detectors shown in the Figures are represented as resistance temperature detectors. Each temperature detector TD1, TD2, TD3, and TD4 can be implemented by any number of individual temperature sensing elements connected in series, in parallel, or in any combination of series and parallel connections, for example.

The temperature detectors TD1 to TD4 can have any suitable size and shape. While each of the temperature detectors TD1 to TD4 are shown in the figures as having a semi-circular shape, other shapes are possible including arcuate, straight, semi-rectangular, etc. In general, higher symmetry improves performance. As the number of temperature detectors increases for a given cavity, the effective cavity shape and temperature detector shape will tend to become circular and arcuate, respectively.

When the heater H is activated by passage of electrical current through nodes 9 and 10, the density of surrounding fluid drops and fluid particles expand towards the temperature detectors. The heater H may be implemented by any suitable heating technology, and may have any suitable dimensions, power rating, etc. The heater H is preferably dimensioned for directionally uniform heating such that the fluid particles expand equally in all directions around the heater H. In some embodiments (not shown), the heater H has an arcuate or circular shape.

It should be noted that the heater H can be steady on or alternately turned on and off using a square, sinusoidal, triangular, sawtooth, or any waveform. It is a feature of the present invention that any variation in the heater power creates effective heat currents.

FIG. 2 illustrates the scenario in which the heater H is activated in the absence of rotation to cause expansion of the contained fluid particles toward the temperature detectors TD1 to TD4, where the straight arrows represent the heat currents. The symmetrical (i.e. directionally uniform) thermal flow about the heater H creates differential voltages at nodes 2|3 and 6|7 having identical magnitudes and opposite polarities. Thus, a superposition of the differential voltages at nodes 2|3 and 6|7 is minimal or zero.

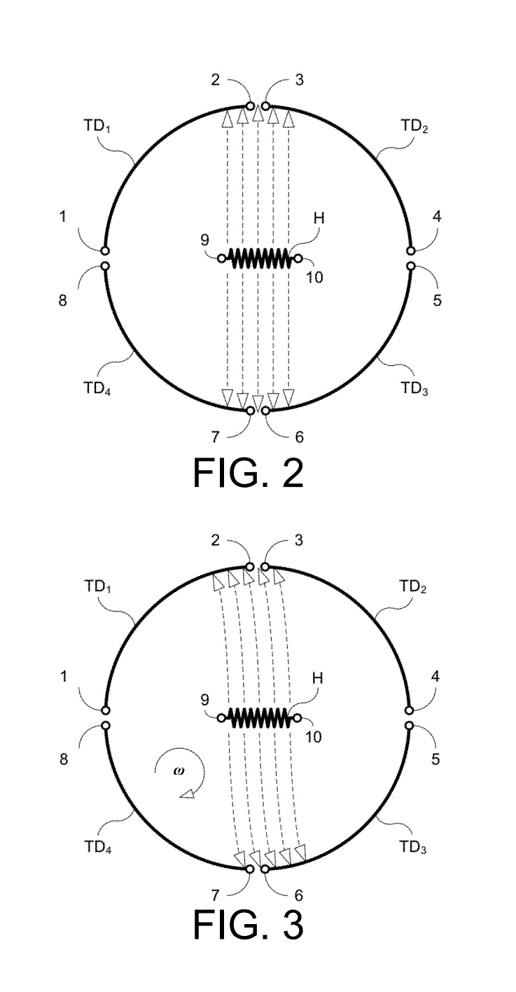

In the presence of rotation ω, the Coriolis effect deviates the thermal currents from a straight path and cause differential temperature measurements between TD1|TD2 and also between TD3|TD4. FIG. 3 shows this scenario in a clockwise rotation where rotation deflects the paths of fluid particles such that TD1 and TD3 sense higher temperature than TD2 and TD4. Hence, the voltage at nodes 2 and 6 will be higher than those at nodes 3 and 7. Thus, the differential voltage between nodes 2|3 is additive to that between nodes 6|7 such that the superposition of these differential voltages has a non-zero magnitude greater than the magnitudes of either of these differential voltages.

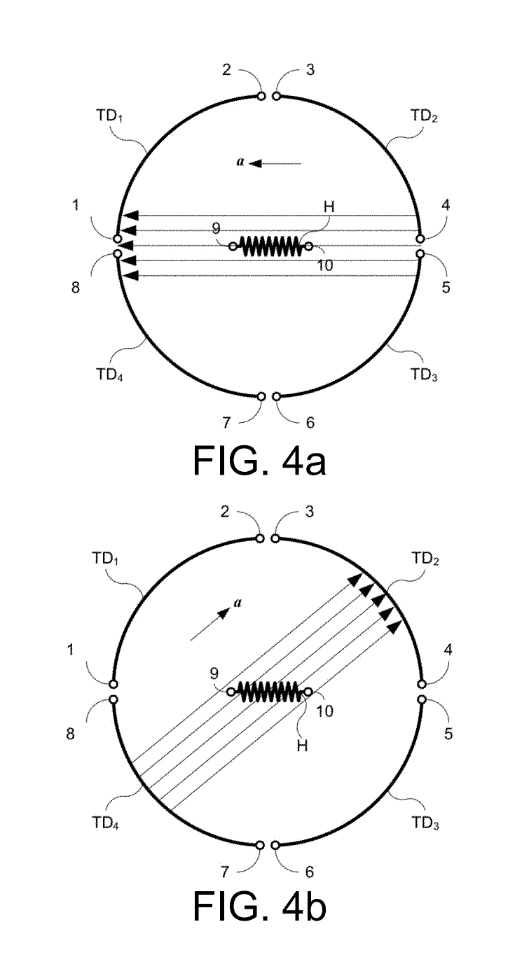

Higher angular rates of rotation induce more deflection and higher temperature and voltage differences. Any temperature rise, induced by the linear acceleration a in any direction of the apparatus such that a convection current is created due to buoyancy of the fluid particles within the fluid, is canceled out by the arrangement and mentioned polarity of the temperature detectors. For instance, consider the two different scenarios shown in FIGS. 4a and 4b. In FIG. 4a, TD1 and TD4 equally heat up by the convection current due to the acceleration, whereas TD2 and TD3 equally cool down by the same convection current. Therefore, the voltage at node 2 is equal to that at node 7 and the voltage at node 3 is equal to that at node 6. After summing up, the differential voltage between nodes 2|3 cancels out with that between nodes 6|7 such that the superposition of these differential voltages is minimal or zero.

Referring to FIG. 4b, TD2 heats up and TD4 cools down by the same convection current. Therefore, the voltage at node 3 is positive while it is negative at node 7. Therefore, the differential voltage between nodes 2|3 is negative whereas it is positive at nodes 6|7. After summing up, these two differential voltages cancel out.

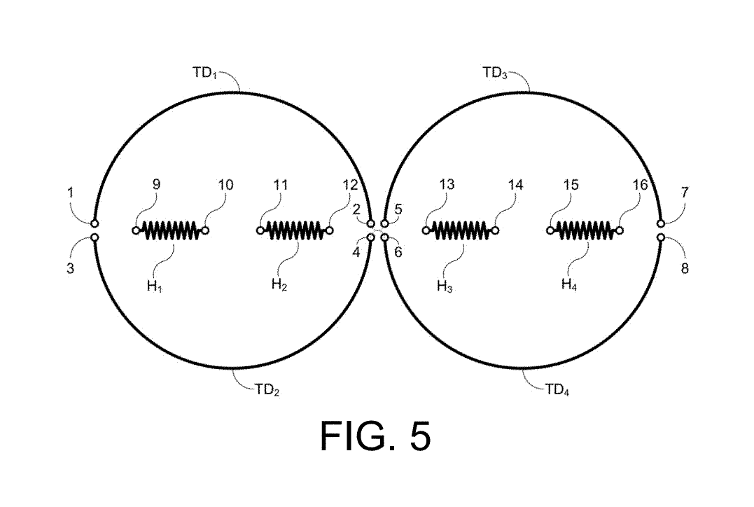

Objectives of the invention can be achieved using more than one heating element. FIG. 5 shows the apparatus in accordance with a second embodiment having a confined volume containing four heating elements H1-H4 and four temperature detectors TD1-TD4. In the embodiment of FIG. 5, the two heating elements H1 and H2 and the two temperature detectors TD1 and TD2 form a first gyroscopic unit, while the two heating elements H3 and H4 and the two temperature detectors TD3 and TD4 form a second gyroscopic unit. The pair of gyroscopic units form a single, exemplary apparatus for sensing the angular rate of rotation in the presence of linear movement.

While FIG. 5 shows all four heaters collinear to each other, such collinear arrangement of heaters H1-H4 is not necessary. Optimal performance is achieved when the first and second gyroscopic units are at least parallel to each other. Heaters H1 and H2 do not need to be collinear with heaters H3 and H4, but can be parallel for example. In variations, the first and second gyroscopic units can be stacked one on top of the other, for example, provided their parallel (i.e. 180 degrees angular relationship) is maintained.

Each heating element H1 to H4 is preferably dimensioned for directionally uniform heating such that the fluid particles expand equally in all directions around each heating element H1 to H4. In some embodiments (not shown), one or more heating elements have an arcuate or circular shape.

In the embodiment shown in FIG. 5, the heaters H1 and H2 are contained within one partitioned cavity, such as a first confined volume, and the heaters H3 and H4 are contained within a separate partitioned cavity, such as a second confined volume, such that fluid flow in the first gyroscopic unit is independent of the fluid flow in the second gyroscopic unit. In a variation, all four heaters H1 to H4 are contained within one confined volume. In such variation, the two gyroscopic units are preferably sufficiently distal from each other to avoid undue interference between the separate fluid flows in the different gyroscopic units. In any event, each pair of heating sources is symmetrically surrounded by associated temperature detectors.

Still referring to FIG. 5, each pair of temperature detectors symmetrically surrounds a pair of the aligned heaters. TD1 and TD4 are connected in series at nodes 2 and 6. Similarly, TD2 and TD3 are in series at nodes 4 and 5. Such cross connections result in the first and second gyroscopic units having a 180 degrees angular relationship. In a variation (not shown), uncrossed connections between the first and second gyroscopic units may be employed while one of the two gyroscopic units of FIG. 5 is rotated 180 degrees relative to the other. In this manner, a 180 degrees angular relationship between the first and second gyroscopic units is maintained.

Although not shown in FIGS. 5, H1 and H4 are in series via nodes 10 and 15, and H2 and H3 are in series via nodes 11 and 14. Nodes 9 and 12 are alternatively driven by an external module. Nodes 7 and 8 are connected to a reference voltage; whereas nodes 1 and 3 are differentially monitored. An exemplary differential-temperature node-pair in accordance with the second embodiment is given by the nodes 1 and 3. In the embodiment shown in FIG. 5, all of the temperature detectors TD1 to TD4 across both gyroscopic units together form the exemplary differential-temperature node-pair of nodes 1 and 3. In the absence of rotation, activation of a heater creates symmetrical (i.e. directionally uniform) fluid expansion toward the temperature detectors.

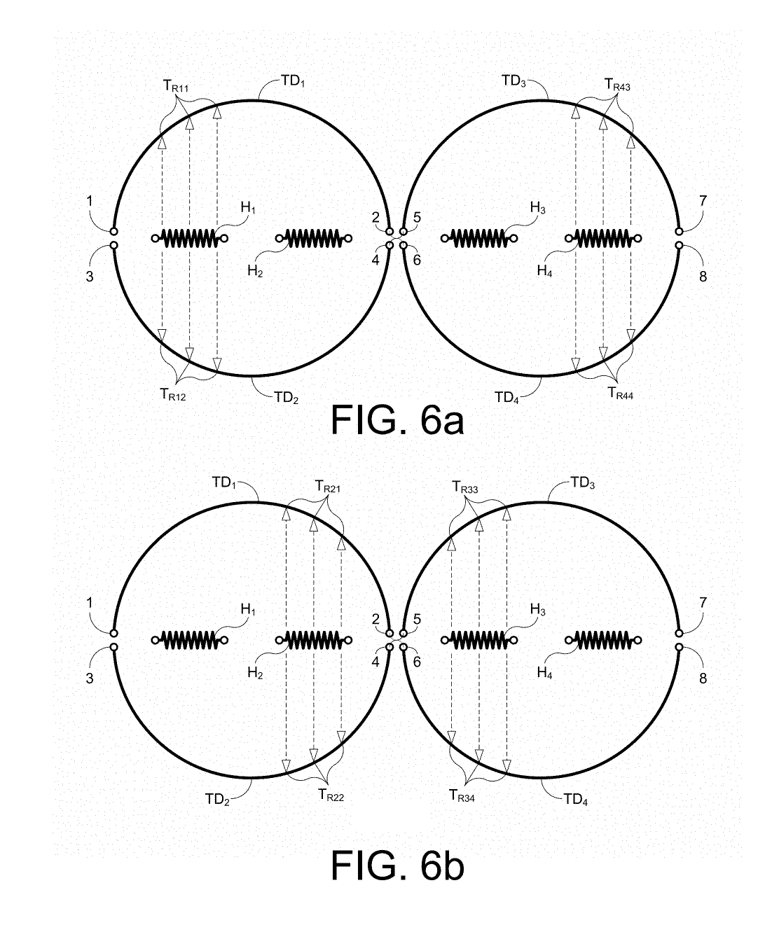

Referring to FIGS. 6a and 6b, a two-phase operation may be employed in which a first set of heaters are activated during a first phase I (FIG. 6a) and a second set of heaters are activated during a second phase II (FIG. 6b). When not rotating, the symmetrical path of the fluid expansion in each phase results in no differential temperature. The sequential activation of sets of heaters sequentially produces differential-temperature indications as sequential differential voltages at the exemplary differential-temperature node-pair of nodes 1 and 3.

FIG. 6a shows simultaneous activation of H1|H4, during phase 1 of operation, where the dashed arrows adjacent H1 and H4 represent the expansion of the fluid particles in the shown directions. The temperature rise at a temperature detector, due to rotation, is TRij where the subscripts i and j respectively identify the heater and temperature detector numbers. For instance, TR43 is the temperature rise created by H4 at TD3. Since there is no rotation, TR11 is equal to TR12 and TR43 is equal to TR44, creating no differential temperature between nodes 1 and 3.

In FIG. 6b, heaters H2 and H3 and their associated arrows represent phase 2 of operation where H2|H3 are activated; however, the differential temperature measured at nodes 1 and 3 remains zero.

In the two-phase operation shown in FIGS. 6a and 6b, an exemplary first differential-temperature indication is produced at nodes 1 and 3 during phase I (FIG. 6a), then subsequently an exemplary second differential-temperature indication is produced at nodes 1 and 3 during phase II (FIG. 6b).

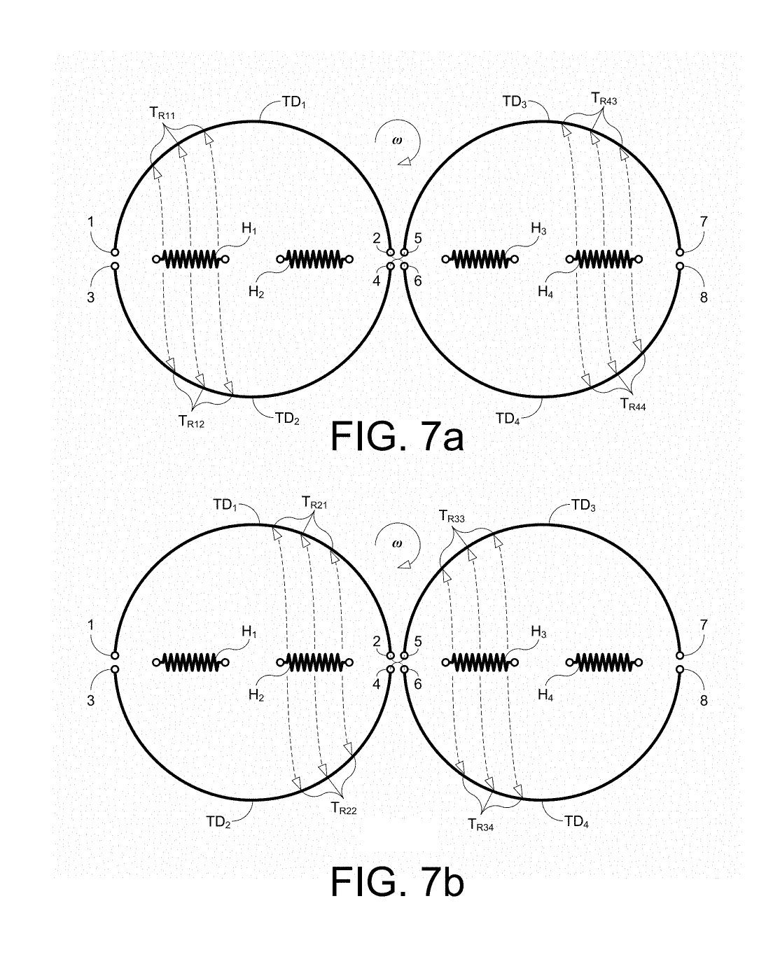

In the presence of a clockwise rotation ω, shown in FIGS. 7a and 7b, the direction of expanding fluid particles deviate from a straight line due to the Coriolis effect. In phase I (FIG. 7a) of operation involving H1 and H4, TR11>TR12 and TR44>TR43; however, TR11=TR44 and TR12=TR43. Therefore, the temperature measured in phase I (FIG. 7a) at node 1 is higher than that at node 3. In phase II (FIG. 7b) involving H2 and H3, TR22>TR21 and TR33>TR34; however, TR22=TR33 and TR21=TR34. Therefore, the temperature measured in phase II (FIG. 7b) at node 3 is higher than that at node 1.

Thus, as shown in FIGS. 7a and 7b, rotation disturbs the symmetry of fluid expansion and results in differential temperature in both phases I (FIG. 7a) and II (FIG. 7b).

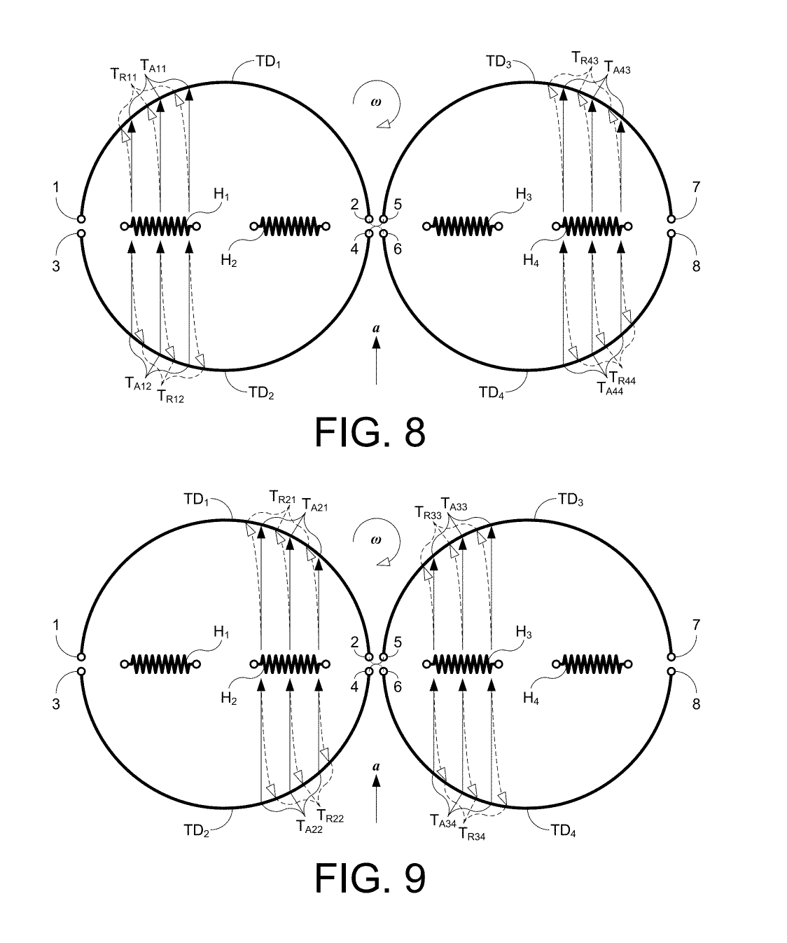

If acceleration a exists in addition to rotation, the convection currents created by the ith heater introduces temperature TAij at the jth temperature detector. FIGS. 8 and 9 show this scenario during phase I (FIG. 8) involving H1 and H4 and phase II (FIG. 9) involving H2 and H3, where the convection currents are illustrated by the solid arrows. Also note that the tip of a convection arrow is filled; whereas the tip of an expansion arrow is hollow.

Referring to FIG. 8, TA43-TA44 is equal to TA11-TA12, and they cancel out between nodes 1 and 3. Therefore, similar to the scenario shown in FIG. 7a, the measured temperature difference of FIG. 8 is caused only by rotation.

Thus, as shown in FIG. 8, in phase I the convection currents created by linear acceleration a equally raise the temperatures of TD2|TD3 and TD1|TD4 such that the net differential temperature between the pairs of temperature detectors is maintained.

Phase II of operation in the presence of acceleration is shown in FIG. 9 where TA21-TA22 is equal to TA33-TA34. Again, any temperature difference due to the imposed acceleration cancels out between nodes 1 and 3. Therefore, the measured temperature difference is due to rotation.

Thus, as shown in FIG. 9, in phase II the convention currents created by linear acceleration a equally raise the temperatures of TD2|TD3 and TD1|TD4 such that the net differential temperature between the pairs of temperature detectors is maintained.

Referring back to FIGS. 1 to 4, the apparatus in accordance with the first embodiment has only one gyroscopic unit, but has two differential-temperature node-pairs. In contrast, the apparatus in accordance with the second embodiment of FIGS. 5 to 9 has two gyroscopic units, but has only one differential-temperature node-pair. Both the first and second embodiments are operable to produce a plurality of differential-temperature indications. In the first embodiment of FIGS. 1 to 4, two differential-temperature indications are simultaneously produced at two differential-temperature node-pairs. In contrast, the second embodiment of FIGS. 5 to 9 is operable to sequentially produce two differential-temperature indications by two phases of operation I and II.

Although the temperature detectors are illustrated in FIGS. 1 to 9 as semicircles, in general they can have any geometry such as arcuate, semi-rectangle, or polygonal. The heaters' geometry is not a limiting factor either. The only constraint for embodiments of FIGS. 5 to 9 is consistency of the geometrical aspects throughout any given sensor such that temperature detectors on opposing sides of given heater(s) are disposed symmetrically on opposing sides of the given heater(s).

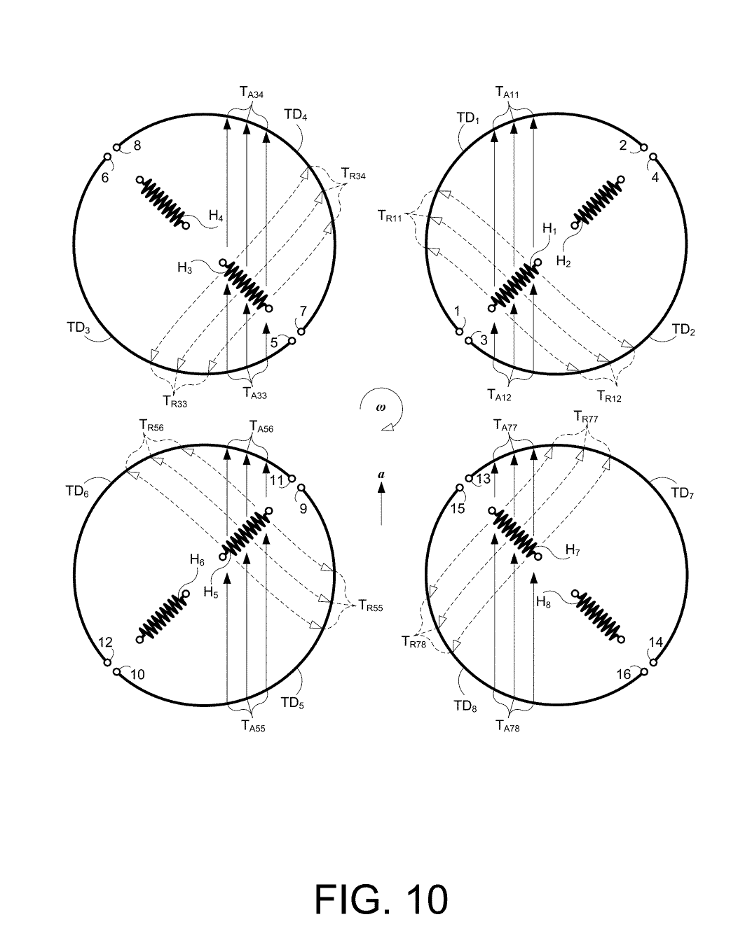

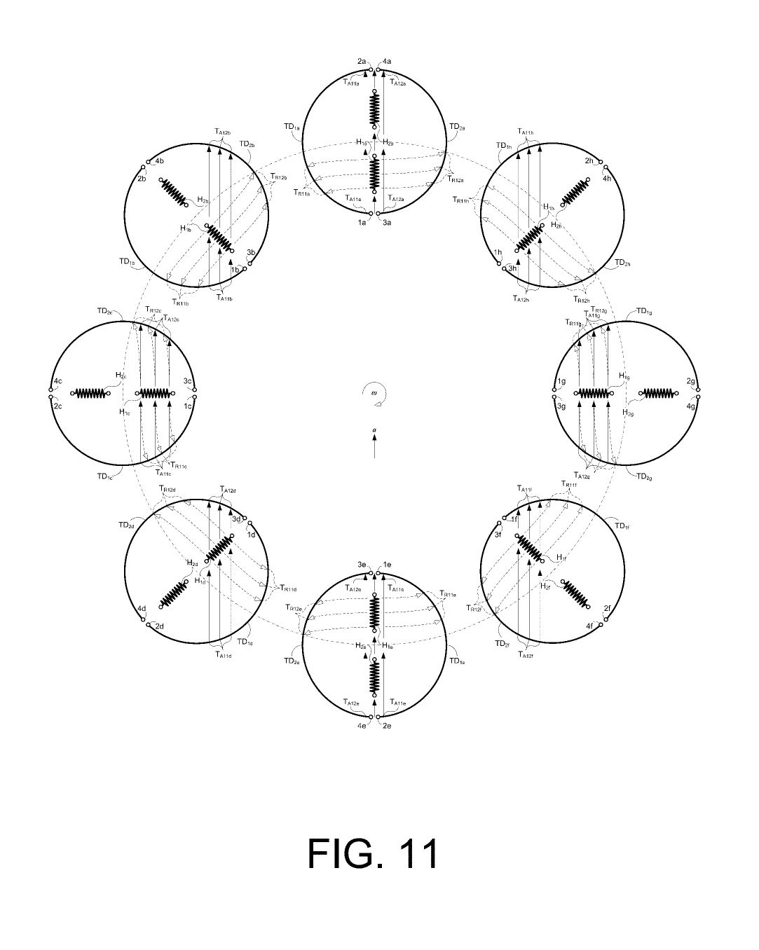

Referring to FIGS. 10 and 11, in further embodiments any number of gyroscopic units may be connected together to form a single rotation sensing apparatus. In variations of embodiments described herein above and below, the rotation sensing apparatus is operable to produce a plurality of differential-temperature indications, which may be simultaneously produced or may be sequentially produced.

In general, each gyroscopic unit may have any shape and any size. Increasing the number gyroscopic units in a given rotation sensing apparatus can improve performance, although it may come at the cost of increased power consumption.

For optimal performance of a rotation sensing apparatus having a plurality of gyroscopic units, the gyroscopic units have an angular relationship. Such angular relationship is preferably given by the angle of a full circle (e.g. 360 degrees) divided by the number of gyroscopic units in the rotation sensing apparatus. For example, in the case of two gyroscopic units (FIGS. 5 to 9) the preferred value of the angular relationship is 360 degrees divided by 2, which is 180 degrees as described herein above with reference to FIG. 5.

As a further example with reference to FIG. 10, in the case of a third embodiment having four (4) gyroscopic units the preferred value of the angular relationship is 360 degrees divided by 4, which is 90 degrees. As can be seen in FIG. 10, the four gyroscopic units are disposed at 90 degrees relative to each other. It is not necessary that the four gyroscopic units be laid out in a square as shown in FIG. 10, and other arrangements that maintain the 90 degree angular relationship are within the scope contemplated by the present invention. For example, some or all of the four gyroscopic units may be stacked one on top another, laid side-by-side, etc.

While not shown in FIG. 10 for clarity of illustration, cross-connections are employed such that the nodes 1 and 5 are electrically connected to each other while the nodes 3 and 7 are connected to each other; the nodes 6 and 10 are connected to each other while the nodes 8 and 12 are connected to each other; and the nodes 9 and 13 are connected to each other while the nodes 11 and 15 are connected to each other. Also, the nodes 2 and 4 are connected to a reference voltage and an exemplary differential-temperature node-pair is formed by the nodes 14 and 16 where differential-temperature indications are sequentially produced by the two phases of operation.

The quad embodiment of FIG. 10 is illustrated with reference to its phase I of operation in which the heaters H1, H3, H5, and H7 are simultaneously activated while the heaters H2, H4, H6, and H8 are de-activated. In phase II of operation (not shown in FIG. 10), the heaters H2, H4, H6, and H8 are activated while the heaters H1, H3, H5, and H7 are de-activated.

As another example with reference to FIG. 11, in the case of a fourth embodiment having eight (8) gyroscopic units labeled a to h the preferred value of the angular relationship is 360 degrees divided by 8, which is 45 degrees. Consistent with FIG. 11, each of the eight gyroscopic units is disposed at 45 degrees relative to its adjacently connected gyroscopic units (the connections of which are further described below). It is not necessary that the four gyroscopic units be laid out around a circle as shown in FIG. 11, and other arrangements that maintain the 45 degree angular relationship are within the scope contemplated by the present invention. For example, some or all of the eight gyroscopic units may be stacked one on top another, laid side-by-side, etc.

While not shown in FIG. 11 for clarity of illustration, cross-connections are employed such that the nodes 1a and 1b are electrically connected to each other while the nodes 3a and 3b are connected to each other; the nodes 2b and 1c are connected to each other while the nodes 4b and 3c are connected to each other; and so on in accordance with the connections indicated in Table 1.

TABLE 1
Connections and Cross-Connections

| Connection | Cross-Connection |
|---|---|
| 1a <==> 1b | 3a <==> 3b |
| 2b <==> 1c | 4b <==> 3c |
| 2c <==> 1d | 4c <==> 3d |
| 2d <==> 1e | 4d <==> 3e |
| 2e <==> 1f | 4e <==> 3f |
| 2f <==> 1g | 4f <==> 3g |
| 2g <==> 1h | 4g <==> 3h |

Also, the nodes 2a and 4a are connected to a reference voltage and an exemplary differential-temperature node-pair is formed by the nodes 2h and 4h where differential-temperature indications are sequentially produced by the two phases of operation.

The embodiment of FIG. 11 is illustrated with reference to its phase I of operation in which the heaters H1a, H1b, H1c, H1d, H1e, H1f, H1g and H1h are simultaneously activated while the heaters H2a to H2h are de-activated. In phase II of operation (not shown in FIG. 11), the heaters H2a to H2h are activated while the heaters H1a to H1h are de-activated.

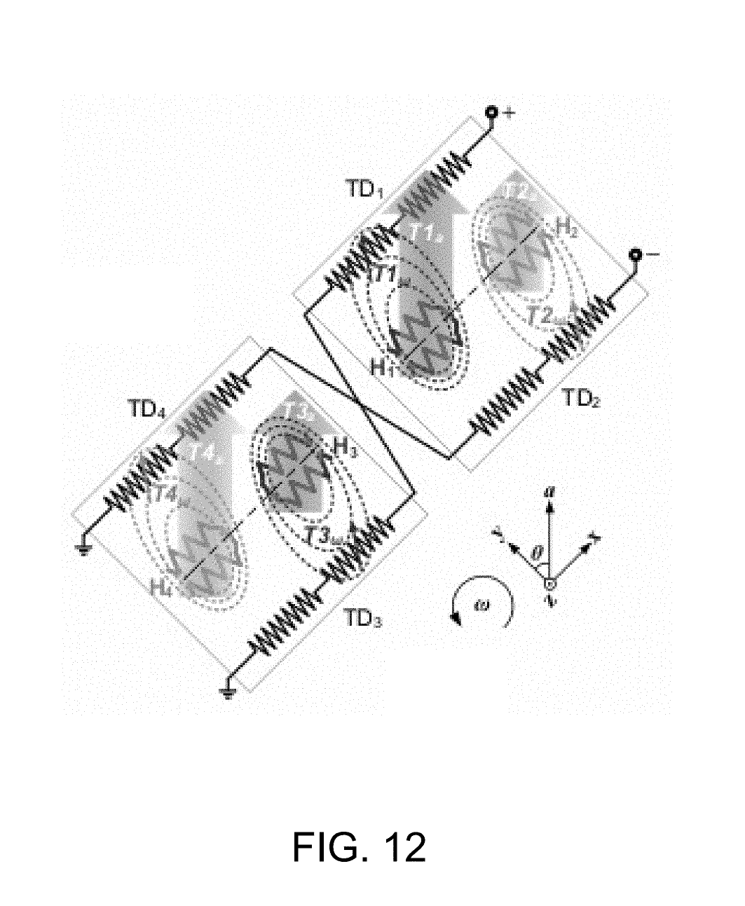

Referring to FIG. 12, a rotation sensing apparatus in accordance with a fifth embodiment is a MEMS-based thermal gyroscope having a configuration of straight, segmented temperature detectors as shown. While FIG. 12 shows each of the temperature detectors TD1, TD2, TD3, and TD4 as being straight and as being segmented in two detection segments, the temperature detectors TD1 to TD4 in general can have any suitable shape and size provided a symmetrical arrangement of temperature detectors about heaters is employed. While the particular shapes and sizes of the temperature detectors may affect actual performance level, the operation and functionality associated with the apparatus of the fifth embodiment (FIG. 12) is similar or analogous to that of the second embodiment (FIGS. 5 to 9).

In the example of FIG. 12, the plane of the gyroscope is rotated by angle θ relative to the direction of linear acceleration a. The temperature rise at each temperature detector can be resolved into two parts. The temperature rise due to rotation ω is illustrated by the dashed ellipses and denoted by Tiω, where i identifies the actuated (i.e. activated) heater. The temperature rise due to linear acceleration in the direction a is shown by the large arrows resembling the natural convection currents and denoted by Tia where i identifies the actuated heater. For simplicity, the bottom portion of these arrows and their cooling effects are neglected. T1ω and T2ω are identical in both phases of operation. However, the T1a and T2a are different as the convection currents generated by H2 partially miss the temperature detector TD1 and hit a cavity wall. If Viω and Via respectively denote the voltages induced by Tiω and Tia, the voltage difference at the temperature detectors is

$$Δ V = \{ \begin{matrix}V {1}_{ω} + V {1}_{a} & I \\ - V {2}_{ω} + V {2}_{a} & II\end{matrix}$$

The gyroscope as configured in FIG. 12 is operable to detect identical net Via's in both phases of operation I and II. As can be seen in FIG. 12, two individual gyroscopic units are put in a cross-series configuration such that each temperature detector of an individual gyroscopic unit is in series with the opposite temperature detector of the other gyroscopic unit. For example, TD1 is connected to TD3, and TD2 is connected to TD4. Although not shown in FIG. 12, the heater pairs H1|H3 and H2|H4 are mutually in series. Unlike the shown configurations, alignment of the heaters of one device to those of the other is not necessary. However, the heaters' line of symmetry must remain parallel to achieve best performance.

Still referring to FIG. 12, the pair of gyroscopic units is operated in two phases. For example, H1|H3 is activated in phase I, and the CCW rotation (ω>0) creates T1ω at TD1 and T3ω at TD3. Also, the natural convection currents impose T1a at TD1 and T3a in the vicinity of TD4 and a cavity wall. Therefore, the voltage difference in phase I is

ΔV_{I}=V1ω+V3ω+V1a−V3a.

In phase II, activation of H2|H4 and rotation create T2ω and T4ω at TD2 and TD4, respectively. The natural convection currents impose T4a at TD4 and T2a in the vicinity of TD1 and a cavity wall. The voltage difference in phase II is

ΔV_{II}=−V2ω−V4ω+V2a−V4a.

Knowing all Viω's are equal and substituting them by ΔVω′, the voltage difference is concisely given as

$$Δ V = \{ \begin{matrix}2 Δ V {ω}^{′} + ( Δ {Va}^{′} - Δ {Va}^{″} ) & I \\ - 2 Δ V {ω}^{′} - ( Δ {Va}^{′} - Δ {Va}^{″} ) & II\end{matrix}$$

where V1a and V4a are equal and substituted by ΔVa′, and the equal V2a and V3a are replaced by ΔVa″. Such equation for voltage difference implies that the cross-series configuration doubles the rotation signal and diminishes the acceleration signal during each phase. Note that this real-time performance is accomplished at the device level right before any amplification and signal conditioning. After polarity reversal and filtering, the doubled rotation signal ΔVω is superposed by a minor acceleration difference ΔVa that is completely canceled if ΔVa′ and ΔVa″ are identical.

The exemplary embodiments described and illustrated herein may be fabricated using any suitable fabrication technology, including MEMS (Micro-Electro-Mechanical System) technology for example. However, the exemplary embodiments described and illustrated herein are not limited to MEMS technology, and may be fabricated as macroscopic devices for example. Both microscopic and macroscopic forms are within the scope contemplated by the present invention.

While not directly shown in the figures, a system that includes the apparatus also includes a processor and memory for performing computations and displaying, storing or otherwise processing the results of such computations. The processing and memory are in electrical communication with each other and with components of the apparatus. The summing operation to determine a superposition sensitive to rotation and insensitive to linear movement can be performed by analogue techniques (e.g. signal conditioning circuitry such as a differential amplifier), by digital techniques (e.g. digital signal processing after analog-to-digital conversion), other means (e.g. manually or inherently), or by any combination thereof for example.

While embodiments of the invention have been described and illustrated, such embodiments should be considered illustrative of the invention only. The invention may include variants not described or illustrated herein in detail. Thus, the embodiments described and illustrated herein should not be considered to limit the invention as construed in accordance with the accompanying claims.

What is claimed is:

1. An apparatus for sensing an angular rate of rotation in the presence of linear movement, the apparatus comprising:
(a) an enclosure for containing a fluid;
(b) a heater disposed within the enclosure in fluid communication with the fluid; and
(c) a plurality of temperature detectors disposed within the enclosure in fluid communication with the heater and the fluid, the plurality of temperature detectors being arranged symmetrically about the heater such that a superposition of a plurality of differential-temperature indications produced by the plurality of temperature detectors is maximally sensitive to the rotation while being minimally sensitive to the linear movement.

2. The apparatus of claim 1 wherein the plurality of temperature detectors form a plurality of differential-temperature node-pairs operable to simultaneously produce the plurality of differential-temperature indications.

3. The apparatus of claim 1 wherein the plurality of temperature detectors form a differential-temperature node-pair operable to sequentially produce each said differential-temperature indication of the plurality of differential-temperature indications.

4. The apparatus of claim 1 wherein the heater and the plurality of temperature detectors form a gyroscopic unit, the apparatus comprising a plurality of the gyroscopic units having an angular relationship.

5. The apparatus of claim 4 wherein the heater of each said gyroscopic unit comprises a plurality of collinear heating elements, and wherein all the temperature detectors of the plurality of gyroscopic units together form a differential-temperature node-pair operable to sequentially produce each said differential-temperature indication of the plurality of differential-temperature indications.

6. The apparatus of claim 5 wherein the plurality of collinear heating elements comprises first and second heating elements associated with first and second differential-temperature indications of the plurality of differential-temperature indications, respectively.

7. The apparatus of claim 6 wherein the plurality of gyroscopic units comprises first and second gyroscopic units having a 180-degree angular relationship.

8. The apparatus of claim 4 wherein the angular relationship has an angular-relationship value defined by a full-circle angle divided by a number of the gyroscopic units.

9. The apparatus of claim 1 wherein the enclosure comprises a plurality of enclosing partitions.

10. The apparatus of claim 1 wherein the heater is dimensioned for directionally uniform heating of the fluid.

11. A method of sensing an angular rate of rotation in the presence of linear movement, the method comprising:
(a) heating a fluid contained within an enclosure by a heater disposed within the enclosure and in fluid communication with the fluid;
(b) producing a plurality of differential-temperature indications by a plurality of temperature indicators in fluid communication with the heater and the fluid; and
(c) determining a superposition of the plurality of differential-temperature indications when the plurality of temperature detectors are arranged symmetrically about the heater such that the superposition is maximally sensitive to the rotation while being minimally sensitive to the linear movement.

12. The method of claim 11 wherein step (b) comprises simultaneously producing the plurality of differential-temperature indications by a plurality of differential-temperature node-pairs formed by the plurality of temperature indicators.

13. The method of claim 11 wherein step (b) comprises sequentially producing each said differential-temperature indication by a differential-temperature node-pair formed by the plurality of temperature indicators.

14. The method of claim 11 wherein step (b) comprises producing the plurality of differential-temperature indications when the heater and the plurality of temperature detectors form a gyroscopic unit and the apparatus comprises a plurality of the gyroscopic units having an angular relationship.

15. The method of claim 14 wherein step (a) comprises heating within each said gyroscopic unit by a plurality of collinear heating elements, and wherein step (b) comprises sequentially producing each said differential-temperature indication by a differential-temperature node-pair formed by all the temperature detectors of the plurality of gyroscopic units.

16. The method of claim 15 wherein heating within each said gyroscopic unit by a plurality of collinear heating elements comprises heating by first and second heating elements associated with first and second differential-temperature indications of the plurality of differential-temperature indications, respectively.

17. The method of claim 16 wherein sequentially producing each said differential-temperature indication by a differential-temperature node-pair formed by all the temperature detectors of the plurality of gyroscopic units comprises producing said each differential-temperature indication when the plurality of gyroscopic units comprises first and second gyroscopic units having a 180-degree angular relationship.

18. The method of claim 14 wherein step (b) comprises producing the plurality of differential-temperature indications when the angular relationship has an angular-relationship value defined by a full-circle angle divided by a number of the gyroscopic units of the plurality of gyroscopic units.

19. The method of claim 11 wherein step (a) comprises heating the fluid contained within a plurality of enclosing partitions of the enclosure.

20. The method of claim 11 wherein step (a) comprises heating directionally uniformly.

21. An apparatus for sensing an angular rate of rotation in the presence of linear movement, the apparatus comprising:
(a) heating means for heating a fluid contained within an enclosure, the heating means being disposed within the enclosure in fluid communication with the fluid;
(b) temperature-detection means for producing a plurality of differential-temperature indications, the temperature detection means being in fluid communication with the heating means and the fluid; and
(c) processing means for determining a superposition of the plurality of differential-temperature indications when the temperature-detection means is arranged symmetrically about the heating means such that the superposition is maximally sensitive to the rotation while being minimally sensitive to the linear movement.
